(19) United States
(12) Patent Application Publication
(10) Pub. No.: US 2026/0368500 A1
(43) Pub. Date: Nov. 19, 2026

(54) SIMULATON OF GENERATIVE ARTIFICIAL INTELLIGENCE MODEL USING BRAIN UTILIZATION INDEX THROUGH COGNITIVE AND NEUROBIOLOGICAL FACTORS

(71) Applicant: Tata Consultancy Services Limited, Mumbai (IN)

(72) Inventors: Arindam HALDER, Kolkata (IN); Saptami PODDER, Kolkata (IN)

(73) Assignee: Tata Consultancy Services Limited, Mumbai (IN)

(21) Appl. No.: 19/676,144

(22) Filed: May 13, 2026

(30) Foreign Application Priority Data
May 14, 2025 (IN) 202521046553

(51) Int. Cl. G06N 3/0475; G06N 3/10

(52) U.S. Cl. CPC G06N 3/0475; G06N 3/10

(57) ABSTRACT

There is a need to optimize generative artificial intelligence (GenAI) based models to behave in a human brain-like in decision making. Conventional systems utilize adaptive neuron activation to optimize performance of the Gen AI based models but are limited to statistical sparsity and semantic adaptability. The present disclosure addresses the unresolved problems of the conventional approaches by providing a system and method for simulation of GenAI model using brain utilization index through cognitive and neurobiological factors. In the present disclosure, A first brain utilization index (BUI) focusing on cognitive factors such as attention, memory, task complexity, mental fatigue, and emotional regulation is used. Also, a second BUI metric emphasizing on neurobiological factors such as neuronal count, sensitivity, latency, and fatigue is used. It is explored how these metrics is applied to development of generative artificial intelligence based models, simulating human-like cognitive functions to improve their efficiency and performance.

### PRIORITY CLAIM

This U.S. patent application claims priority under 35 U.S.C. § 119 to: India application No. 202521046553, filed on May 14, 2025. The entire contents of the aforementioned application are incorporated herein by reference.

### TECHNICAL FIELD

The disclosure herein generally relates to the field of simulation of generative artificial intelligence, and, more particularly, to simulation of generative artificial intelligence model using brain utilization index through cognitive and neurobiological factors.

### BACKGROUND

The human brain is an intricate organ with remarkable cognitive capabilities, but its anatomical structure and physiological constraints can limit its full potential. One of the most pressing challenges in modern neuroscience and cognitive psychology is understanding how these limitations affect its ability to focus, multitask, and perform complex cognitive tasks efficiently. By understanding these limitations, especially in multitasking scenarios, brain utilization is better assessed through a Brain Utilization Index (BUI). With the advent of technology, generative artificial intelligence has been used for simulating the human brain. Correlation of the Gen AI with Human Brain enables better decision making. Thus, there is a need to optimize the Gen AI based models to behave in a more human brain-like in decision making. Conventional systems utilize adaptive neuron activation to optimize performance of the Gen AI based models. However, they are limited to statistical sparsity and semantic adaptability.

### SUMMARY

Embodiments of the present disclosure present technological improvements as solutions to one or more of the above-mentioned technical problems recognized by the inventors in conventional systems. For example, in one embodiment, a processor implemented method is provided. The processor implemented method, comprising: receiving, via one or more hardware processors, a plurality of input data pertaining to one or more task oriented activities; preprocessing, via the one or more hardware processors, the plurality of input data using one or more preprocessing techniques to obtain a plurality of preprocessed input data; computing, via the one or more hardware processors, (i) a first brain utilization index (BUI) metric using a plurality of cognitive factors and (ii) a second brain utilization index (BUI) metric using a plurality of neurobiological factors for each of the plurality of preprocessed input data, wherein the plurality of cognitive factors comprises (i) an attention factor, (ii) a memory load factor, (iii) a task complexity, (iv) a cognitive fatigue factor, and (v) an emotional state factor, and wherein the plurality of neurobiological factors comprises (a) number of sensitive neurons, (b) a neuronal sensitivity factor, (c) an input time processing factor complexity, (d) a neurobiological fatigue factor, and (e) a latency factor; obtaining, via the one or more hardware processors, a final BUI metric by integrating the first BUI metric and the second BUI metric for each of the plurality of preprocessed input data; determining in real time, via the one or more hardware processors, a complexity measure associated each of the plurality of preprocessed input data using the final BUI metric; designing, via the one or more hardware processors, a generative artificial intelligence (Gen AI) based model with a task scheduler that is simulated using the final BUI metric, wherein the Gen AI based model comprises one more neuron sensing layers, one or more hidden layers, one or more optimization layers, one or more management layers, and a plurality of attention layers, wherein the plurality of attention layers are implemented with a dynamic attention mechanism that adjusts focus of the Gen AI based model for performing one or more task oriented activities based on the complexity measure associated each of the plurality of preprocessed input data; and enabling, via the one or more hardware processors, the Gen AI based model to perform one or more human-like cognitive functions with improved efficiency and decision making, wherein the one or more human-like cognitive functions performed by the Gen AI based model comprises at least one (i) a task prioritization based on task complexity and memory requirements, (ii) parallel processing using multiple attention heads, (iii) neural activation simulation through selective activation of at least one of: (a) one or more hidden layers, and (b) one or more neurons in the Gen AI based model based on task difficulty, (c) latency-aware processing by adjusting response time of the Gen AI based model based on the task complexity and task latency, (d) dynamic resource allocation using an attention index, and (e) fatigue handling using a fatigue management layer from the one or more management layers of the Gen AI based model.

In another aspect, a system is provided. The system comprising a memory storing instructions; one or more communication interfaces; and one or more hardware processors coupled to the memory via the one or more communication interfaces, wherein the one or more hardware processors are configured by the instructions to: receive a plurality of input data pertaining to one or more task oriented activities; preprocess the plurality of input data using one or more preprocessing techniques to obtain a plurality of preprocessed input data; compute (i) a first brain utilization index (BUI) metric using a plurality of cognitive factors and (ii) a second brain utilization index (BUI) metric using a plurality of neurobiological factors for each of the plurality of preprocessed input data, wherein the plurality of cognitive factors comprises (i) an attention factor, (ii) a memory load factor, (iii) a task complexity, (iv) a cognitive fatigue factor, and (v) an emotional state factor, and wherein the plurality of neurobiological factors comprises (a) number of sensitive neurons, (b) a neuronal sensitivity factor, (c) an input time processing factor complexity, (d) a neurobiological fatigue factor, and (e) a latency factor; obtain a final BUI metric by integrating the first BUI metric and the second BUI metric for each of the plurality of preprocessed input data; determine a complexity measure associated each of the plurality of preprocessed input data using the final BUI metric; design a generative artificial intelligence (Gen AI) based model with a task scheduler that is simulated using the final BUI metric, wherein the Gen AI based model comprises one more neuron sensing layers, one or more hidden layers, one or more optimization layers, one or more management layers, and a plurality of attention layers, wherein the plurality of attention layers are implemented with a dynamic attention mechanism that adjusts focus of the Gen AI based model for performing one or more task oriented activities based on the complexity measure associated each of the plurality of preprocessed input data; and enable the Gen AI based model to perform one or more human-like cognitive functions with improved efficiency and decision making, wherein the one or more human-like cognitive functions performed by the Gen AI based model comprises at least one (i) a task prioritization based on task complexity and memory requirements, (ii) parallel processing using multiple attention heads, (iii) neural activation simulation through selective activation of at least one of: (a) one or more hidden layers, and (b) one or more neurons in the Gen AI based model based on task difficulty, (c) latency-aware processing by adjusting response time of the Gen AI based model based on the task complexity and task latency, (d) dynamic resource allocation using an attention index, and (e) fatigue handling using a fatigue management layer from the one or more management layers of the Gen AI based model.

In yet another aspect, there are provided one or more non-transitory machine-readable information storage mediums comprising one or more instructions which when executed by one or more hardware processors cause receiving a plurality of input data pertaining to one or more task oriented activities; preprocessing the plurality of input data using one or more preprocessing techniques to obtain a plurality of preprocessed input data; computing (i) a first brain utilization index (BUI) metric using a plurality of cognitive factors and (ii) a second brain utilization index (BUI) metric using a plurality of neurobiological factors for each of the plurality of preprocessed input data, wherein the plurality of cognitive factors comprises (i) an attention factor, (ii) a memory load factor, (iii) a task complexity, (iv) a cognitive fatigue factor, and (v) an emotional state factor, and wherein the plurality of neurobiological factors comprises (a) number of sensitive neurons, (b) a neuronal sensitivity factor, (c) an input time processing factor complexity, (d) a neurobiological fatigue factor, and (e) a latency factor; obtaining a final BUI metric by integrating the first BUI metric and the second BUI metric for each of the plurality of preprocessed input data; determining in real time, a complexity measure associated each of the plurality of preprocessed input data using the final BUI metric; designing a generative artificial intelligence (Gen AI) based model with a task scheduler that is simulated using the final BUI metric, wherein the Gen AI based model comprises one more neuron sensing layers, one or more hidden layers, one or more optimization layers, one or more management layers, and a plurality of attention layers, wherein the plurality of attention layers are implemented with a dynamic attention mechanism that adjusts focus of the Gen AI based model for performing one or more task oriented activities based on the complexity measure associated each of the plurality of preprocessed input data; and enabling the Gen AI based model to perform one or more human-like cognitive functions with improved efficiency and decision making, wherein the one or more human-like cognitive functions performed by the Gen AI based model comprises at least one (i) a task prioritization based on task complexity and memory requirements, (ii) parallel processing using multiple attention heads, (iii) neural activation simulation through selective activation of at least one of: (a) one or more hidden layers, and (b) one or more neurons in the Gen AI based model based on task difficulty, (c) latency-aware processing by adjusting response time of the Gen AI based model based on the task complexity and task latency, (d) dynamic resource allocation using an attention index, and (e) fatigue handling using a fatigue management layer from the one or more management layers of the Gen AI based model.

In accordance with an embodiment of the present disclosure, the first brain utilizing index (BUI) metric is computed as

$${BUI}_{1} = \frac{α ( A ) + β ( M ) + γ ( {T}_{1} ) + δ ( {F}_{1} ) + ϵ ( E )}{α + β + γ + δ + ϵ} ,$$

where A represents the attention factor, M represents the memory load factor, T₁ represents the task complexity, F₁ represents the cognitive fatigue factor, E represents the emotion state factor, and α, β, γ, δ, ∈ represent weights that adjust an importance of each of the plurality of cognitive factors based on a context.

In accordance with an embodiment of the present disclosure, the second brain utilizing index (BUI) metric is computed as

$${BUI}_{2} = \frac{N \times S \times {T}_{2}^{0.5}}{L \times {F}_{2}} ,$$

where N represents number of sensitive neurons, S represents a neuronal sensitivity factor, T₂ represents an input time processing factor, L represents a latency factor, and F₂ represents the neurobiological fatigue factor.

In accordance with an embodiment of the present disclosure, the number of sensitive neurons is modulated based on (i) a task sensitivity, and (ii) the task complexity to ensure an efficient computational power utilization.

In accordance with an embodiment of the present disclosure, the fatigue management layer of the Gen AI based model manages resource allocation and prevent overload by tracking amount of computational power being used and redistributing one or more tasks when one or more parts of the Gen AI based model attain a fatigue nature.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary system for simulation of generative artificial intelligence model using brain utilization index through cognitive and neurobiological factors, according to some embodiments of the present disclosure.

FIGS. 2A and 2B, with reference to FIG. 1, illustrates an exemplary flow diagram illustrating a method for simulation of generative artificial intelligence model using brain utilization index through cognitive and neurobiological factors, using the system of FIG. 1, in accordance with some embodiments of the present disclosure.

### DETAILED DESCRIPTION OF EMBODIMENTS

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following embodiments described herein.

With the advent of technology, generative artificial intelligence has been used for simulating the human brain. Correlation of the Gen AI with Human Brain enables better decision making. There is a need to optimize Gen AI based models to behave in a more human brain-like in decision making. Conventional systems utilize adaptive neuron activation to optimize performance of the Gen AI based models. However, they are limited to statistical sparsity and semantic adaptability.

The present disclosure addresses the unresolved problems of the conventional approaches by providing a system and method for simulation of generative artificial intelligence model using brain utilization index through cognitive and neurobiological factors. In the present disclosure, two different metric for calculating the brain utilization index (BUI) are used, where one metric focuses on cognitive factors such as attention, memory, task complexity, mental fatigue, and emotional regulation, another metric emphasizes on neurobiological factors like neuronal count, sensitivity, latency, and fatigue. Through a comparative analysis of these metrics, insights into how BUI can be optimized to enhance productivity and focus are provided. Furthermore, it is explored how these metrics can be applied to development of generative artificial intelligence based models such as Large Language Models (LLMs), simulating one or more human-like cognitive functions to improve their efficiency and performance.

The integration of cognitive and neurobiological elements into LLM architectures represents a significant step forward in creating more human-like AI systems. As BUI-based models evolve, LLMs not only become more efficient but also more emotionally aware, capable of handling complex real-world tasks with same flexibility and resilience that humans exhibit. This transforms how AI interacts with humans, making responses more intuitive, accurate, and aligned with human reasoning processes. The first metric can directly influence how LLMs dynamically allocate resources, optimize attention mechanisms, and simulate multitasking. The second metric is integrated in the LLM architectures to enhance neural efficiency, latency management, and computational load balancing for ensuring optimized performance even under complex and time-sensitive scenarios.

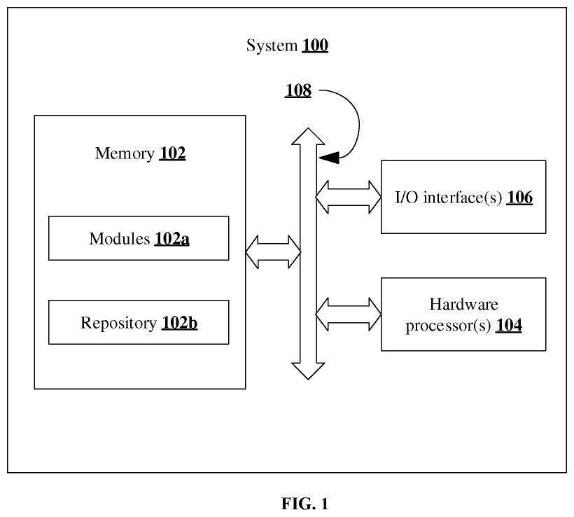

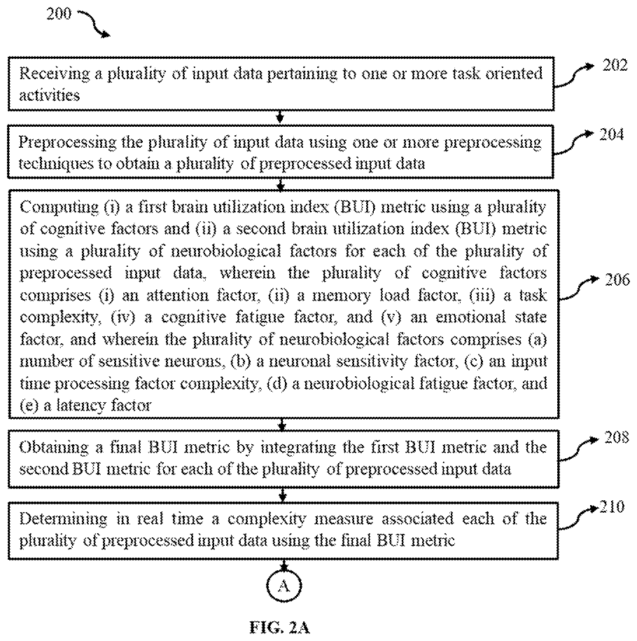

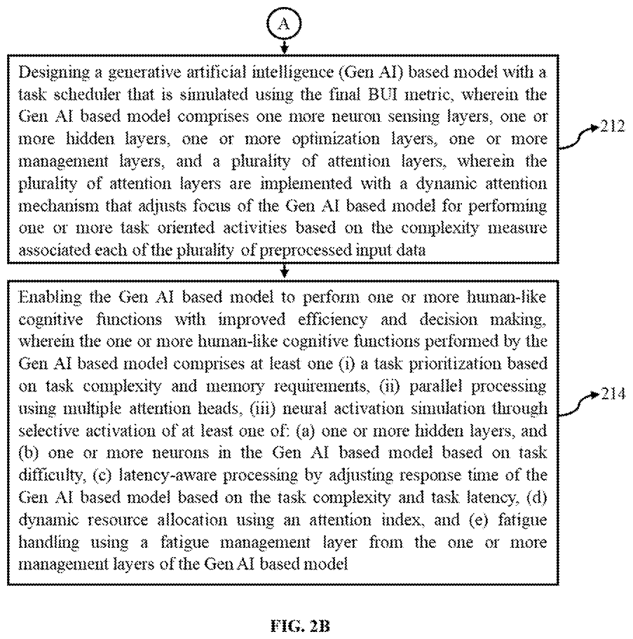

Referring now to the drawings, and more particularly to FIGS. 1 through 2, where similar reference characters denote corresponding features consistently throughout the figures, there are shown preferred embodiments, and these embodiments are described in the context of the following exemplary system and/or method.

FIG. 1 illustrates an exemplary system for simulation of generative artificial intelligence model using brain utilization index through cognitive and neurobiological factors, according to some embodiments of the present disclosure. In an embodiment, the system 100 includes or is otherwise in communication with one or more hardware processors 104, communication interface device(s) or input/output (I/O) interface(s) 106, and one or more data storage devices or memory 102 operatively coupled to the one or more hardware processors 104. The one or more hardware processors 104, the memory 102, and the I/O interface(s) 106 may be coupled to a system bus 108 or a similar mechanism.

The I/O interface(s) 106 may include a variety of software and hardware interfaces, for example, a web interface, a graphical user interface, and the like. The I/O interface(s) 106 may include a variety of software and hardware interfaces, for example, interfaces for peripheral device(s), such as a keyboard, a mouse, an external memory, a plurality of sensor devices, a printer and the like. Further, the I/O interface(s) 106 may enable the system 100 to communicate with other devices, such as web servers and external databases.

The I/O interface(s) 106 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface(s) 106 may include one or more ports for connecting a number of computing systems with one another or to another server computer. Further, the I/O interface(s) 106 may include one or more ports for connecting a number of devices to one another or to another server.

The one or more hardware processors 104 may be implemented as one or more microprocessors, microcomputers, microcontrollers, digital signal processors, central processing units, state machines, logic circuitries, and/or any devices that manipulate signals based on operational instructions. Among other capabilities, the one or more hardware processors 104 are configured to fetch and execute computer-readable instructions stored in the memory 102. In the context of the present disclosure, the expressions ‘processors’ and ‘hardware processors’ may be used interchangeably. In an embodiment, the system 100 can be implemented in a variety of computing systems, such as laptop computers, portable computer, notebooks, hand-held devices, workstations, mainframe computers, servers, a network cloud and the like.

The memory 102 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, the memory 102 includes a plurality of modules 102a and a repository 102b for storing data processed, received, and generated by one or more of the plurality of modules 102a. The plurality of modules 102a may include routines, programs, objects, components, data structures, and so on, which perform particular tasks or implement particular abstract data types.

The plurality of modules 102a may include programs or computer-readable instructions or coded instructions that supplement applications or functions performed by the system 100. The plurality of modules 102a may also be used as, signal processor(s), state machine(s), logic circuitries, and/or any other device or component that manipulates signals based on operational instructions. Further, the plurality of modules 102a can be used by hardware, by computer-readable instructions executed by the one or more hardware processors 104, or by a combination thereof. Further, the memory 102 may include information pertaining to input(s)/output(s) of each step performed by the processor(s) 104 of the system 100 and methods of the present disclosure.

The repository 102b may include a database or a data engine. Further, the repository 102b amongst other things, may serve as a database or includes a plurality of databases for storing the data that is processed, received, or generated as a result of the execution of the plurality of modules 102a. Although the repository 102b is shown internal to the system 100, it will be noted that, in alternate embodiments, the repository 102b can also be implemented external to the system 100, where the repository 102b may be stored within an external database (not shown in FIG. 1) communicatively coupled to the system 100. The data contained within such external database may be periodically updated. For example, new data may be added into the external database and/or existing data may be modified and/or non-useful data may be deleted from the external database. In one example, the data may be stored in an external system, such as a Lightweight Directory Access Protocol (LDAP) directory and a Relational Database Management System (RDBMS). In another embodiment, the data stored in the repository 102b may be distributed between the system 100 and the external database.

FIGS. 2A and 2B illustrate an exemplary flow diagram illustrating a method for simulation of generative artificial intelligence model using brain utilization index through cognitive and neurobiological factors, using the system of FIG. 1, in accordance with some embodiments of the present disclosure.

Referring to FIGS. 2A and 2B, in an embodiment, the system(s) 100 comprises one or more data storage devices or the memory 102 operatively coupled to the one or more hardware processors 104 and is configured to store instructions for execution of steps of the method by the one or more processors 104. The steps of the method 200 of the present disclosure will now be explained with reference to components of the system 100 of FIG. 1, the flow diagram as depicted in FIGS. 2A and 2B, and one or more examples. Although steps of the method 200 including process steps, method steps, techniques or the like may be described in a sequential order, such processes, methods and techniques may be configured to work in alternate orders. In other words, any sequence or order of steps that may be described does not necessarily indicate a requirement that the steps be performed in that order. The steps of processes described herein may be performed in any practical order. Further, some steps may be performed simultaneously, or some steps may be performed alone or independently.

In an embodiment, at step 202 of the present disclosure, one or more hardware processors 104 are configured to receive a plurality of input data pertaining to one or more task oriented activities. The plurality of input data may include but are not limited to an image, a text, an audio, a video, and/or the like. Further, at step 204 of the present disclosure, the one or more hardware processors 104 are configured to preprocess the plurality of input data using one or more preprocessing techniques to obtain a plurality of preprocessed input data. The one or more preprocessing techniques may comprise but ae not limited to cleaning, filtering, outlier detection and elimination, normalization, and/or the like.

At step 206 of the present disclosure, the one or more hardware processors 104 are configured to compute (i) a first brain utilization index (BUI) metric using a plurality of cognitive factors and (ii) a second brain utilization index (BUI) metric using a plurality of neurobiological factors for each of the plurality of preprocessed input data. The plurality of cognitive factors comprises (i) an attention factor, (ii) a memory load factor, (iii) a task complexity, (iv) a cognitive fatigue factor, and (v) an emotional state factor. The first brain utilizing index (BUI) metric is computed as

$${BUI}_{1} = \frac{α ( A ) + β ( M ) + γ ( {T}_{1} ) + δ ( {F}_{1} ) + ϵ ( E )}{α + β + γ + δ + ϵ} ,$$

where A represents the attention factor, M represents the memory load factor, T₁ represents the task complexity, F₁ represents the cognitive fatigue factor, E represents the emotion state factor, and α, β, γ, δ, ∈ represent weights that adjust an importance of each of the plurality of cognitive factors based on a context. This ensures that all factors contribute proportionally, and BUI is normalized between 0 and 1. The first brain utilizing index (BUI) metric acts as a high level decision layer identifying where cognitive resources are overloaded.

The attention factor A represents how much focus is allocated to a task. In humans, the attention factor A is measured via eye-tracking, Electroencephalogram (EEG)-based attention levels, or task engagement scores (e.g., how long a subject maintains focus on a screen). For Gen AI models such as in an LLM, the attention factor is derived from self-attention scores in transformer models. A higher attention score means the LLM model is prioritizing certain tokens. Real-time calculation of the Attention Factor is performed using equation (1) below:

$$A = \frac{{\sum }_{i}^{n} Attention Score}{n} \qquad ( 1 )$$

Here, the attention score is obtained from an attention matrix in transformers (or human focus tracking for non-AI applications).

The memory load factor M measures an amount of working memory utilized. In humans, the memory load factor M is measured by active working memory tests (e.g., remembering numbers or performing dual tasks simultaneously). For Gen AI models such as in the LLM, the memory load factor M is measured as number of tokens stored in the LLM model's context window determines memory load. If a task requires retrieving long-term memory, the memory load increases. Real-time calculation of Memory Load (M) is performed using equation (2) below:

$$M = \frac{( Working Memory Used )}{( Total Available Memory )} \qquad ( 2 )$$

Here, Working Memory Used is a proportion of memory occupied by active tokens or neural activations.

The task complexity T₁ reflects how difficult or resource-intensive the task is. In humans, the task complexity T₁ is assessed by reaction time tests, error rates, and problem-solving difficulty ratings. For Gen AI models such as in the LLM, the task complexity T₁ depends on a number of layers in a computation graph required for inference, depth of neural network activation required to process an input, and number of tokens used for processing (e.g., summarizing a 10,000-token document is more complex than a 500-token one). Real-time calculation of the task complexity T₁ is performed using equation (3) below:

$$T = \frac{Processing Steps Required}{Maximum Possible Processing Steps} \qquad ( 3 )$$

Here, Processing Steps Required is determined by depth of computation, number of decisions, or token length in Gen AI models.

The cognitive fatigue factor F₁ captures cognitive wear-out from prolonged engagement. In humans, the cognitive fatigue factor F₁ is measured based on monitoring using EEG fatigue levels, reaction time delays, error rate increases, or self-reported tiredness scores. For Gen AI models such as in the LLM, the cognitive fatigue factor F₁ is measured via computational exhaustion, where layers get overused (e.g., an LLM being queried continuously without a processing gap leads to model degradation). Real-time calculation of the cognitive fatigue factor F₁ is performed using equation (4) below:

$$F = \frac{Time Spent on Task}{Optimal Engagement Time} \qquad ( 4 )$$

Here, Optimal Engagement Time is the threshold beyond which performance degrades.

The emotion state factor E measures how emotions (e.g., stress, motivation) influence performance. In humans, the emotion state factor E is inferred via facial expression analysis, heart rate visibility, and sentiment analysis from speech or text. For Gen AI models such as in the LLM, the emotion state factor E are analyzed as sentiment polarity of user queries (negative sentiment indicates stress, which reduces efficiency). Real-time calculation of the emotion state factor E is performed using equation (5) below:

$$E = \frac{Emotion Score}{Max Emotion Intensiy} \qquad ( 5 )$$

Here, Emotion Score is derived from sentiment analysis tools (for humans, it could be measured from speech and for Gen AI, it could be computed from user input tone).

The plurality of neurobiological factors comprises (a) number of sensitive neurons, (b) a neuronal sensitivity factor, (c) an input time processing factor complexity, (d) a neurobiological fatigue factor, and (e) a latency factor. The second brain utilizing index (BUI) metric is computed as

$${BUI}_{2} = \frac{N \times S \times {T}_{2}^{0.5}}{L \times {F}_{2}} ,$$

where N represents number of sensitive neurons, S represents a neuronal sensitivity factor, T₂ represents an input time processing factor, L represents a latency factor, and F₂ represents the neurobiological fatigue factor. The second brain utilizing index (BUI) metric acts as a low-level execution layer, ensuring number of sensitive neurons, the latency factor and the neuronal sensitivity factor are optimized to support the first BUI metric goals. Higher value of the second BUI metric indicates efficient brain utilization (i.e., high neuron activation, quick response) and the lower value of the second BUI metric indicates inefficient processing (i.e., fatigue, latency, and limited neural engagement).

The number of sensitive neurons N represents the number of neurons actively processing a task at a given moment. The number of sensitive neurons is modulated based on (i) a task sensitivity, and (ii) the task complexity to ensure an efficient computational power utilization. In humans, the number of sensitive neurons N is measured using EEG and fMRI scans to detect neuron activations. Here, higher value of N means more neurons are engaged during high-focus or multitasking tasks. For Gen AI models such as in the LLM, the number of sensitive neurons N is equivalent to a number of active computational units (neurons/layers) participating in inference. Here, higher value of N means more layers/neurons used for a complex query. Real-time calculation of the number of sensitive neurons N is performed using equation (6) below:

$$N = \frac{Number of Active Neurons}{Total Available Neurons} \qquad ( 6 )$$

Gen AI models track layer activations during processing to estimate N.

The neuronal sensitivity factor S indicates how efficiently neurons respond to a stimuli in a range of 0 to 1. In humans, the neuronal sensitivity factor S is measured by reaction speed, neural response efficiency, and neurotransmitter release rate. Here, higher value of S indicate faster and more efficient neural processing. For Gen AI models such as in the LLM, the neuronal sensitivity factor S is equivalent to weight activation efficiency in neural networks which means how well neurons adjust to new information and measured by synaptic strength in biological systems and weight updates in AI. Real-time calculation of the neuronal sensitivity factor S is performed using equation (7) below:

$$S = \frac{Neuron Response Rate}{Max Response Rate} \qquad ( 7 )$$

Gen AI models adjust S based on how efficiently attention layers adapt to new data.

The input time processing factor T₂ represents a total duration spent processing a given input. In humans, the input time processing factor T₂ is measured as time taken to process and respond to stimuli (e.g., solving a math problem, reacting to a stimulus). More difficult tasks require higher processing time. For Gen AI models such as in the LLM, the input time processing factor T₂ is an inference time required per input token (higher complexity is equal to longer processing time) and measured by elapsed computation time per query. Real-time calculation of the input time processing factor T₂ is performed using equation (8) below:

T₂=End Time−Start Time (8)

Gen AI models measure T using timestamp logging.

The latency factor L represents a time delay between receiving input and generating a response. In humans, the latency factor L is measured as a time delay between stimulus perception and motor/cognitive response (e.g., reaction time to light or sound). Increased latency indicates cognitive overload or stress. For Gen AI models such as in the LLM, the latency factor L is measured as a processing delay between receiving an input and generating output. Longer L indicates slower response due to computational bottlenecks. Real-time calculation of the latency factor L is performed using equation (9) below:

$$L = \frac{Neural Signal Processing Delay}{Total Input Size} \qquad ( 9 )$$

Gen AI models track layer-wise execution time to estimate L.

The neurobiological fatigue factor F₂ represents depletion of neural resources due to prolonged activity in a range of 0 to 1. In humans, neurobiological fatigue factor F₂ increases when neurons fire continuously without rest and is measured via EEG wave changes, error rates, and reaction slowdown. For Gen AI models such as the LLM, the neurobiological fatigue factor F₂ is simulated by tracking overuse of layers, increased inference time, or model drift. Higher F₂ indicates that the LLM model is overworked and needs load balancing. Real-time calculation of the latency factor L is performed using equation (10) below:

$${F}_{2} = \frac{Time Active}{Optimal Activity Window} \qquad ( 10 )$$

Gen AI models calculate F₂ using GPU/CPU load metrics.

At step 208 of the present disclosure, the one or more hardware processors 104 are configured to obtain a final BUI metric by integrating the first BUI metric and the second BUI metric for each of the plurality of preprocessed input data. The final BUI metric incorporates sentiment, cognitive fatigue, and memory dynamics, making it a multifaceted long term optimization tool and a unique way to quantify system performance. The real-time calculation of the final BUI metric requires continuous monitoring of each parameter using neuroscience-based tests such as EEG, fMRI, reaction time tests or Gen AI models parameters such as activation layers, response speed, and computational load.

In an embodiment, selection of individual components of each of the first BUI metric and the second BUI metric is inspired by both cognitive psychology and neuroscience. These individual components of each of the first BUI metric and the second BUI metric are computed dynamically based on real-time adaptive monitoring using measurable parameters in human cognition and AI systems. The integration of the first BUI metric and the second BUI metric to obtain the final BUI metric makes it a comprehensive and actionable metric. A real-time scores of individual components of each of the first BUI metric and the second BUI metric are computed continuously during LLM inference. These values fluctuate dynamically, reflecting system's current workload and efficiency. The final BUI metric (i) optimizes attention allocation where more neurons are activated for complex high attention tasks, (ii) manages memory load where if memory usage is high, then the second BUI metric adjust neuron sensitivity to balance processing, (iii) prevents model fatigue where if fatigue is detected, tasks are redistributed across processing layers and (iv) reduces latency dynamically where if a high priority tasks require fast response, then the second BUI metric ensures lower latency (L).

Further, at step 210 of the present disclosure, the one or more hardware processors 104 are configured to determine in real time a complexity measure associated each of the plurality of preprocessed input data using the final BUI metric. The complexity measure associated with each of the plurality of preprocessed input data is also referred to as input complexity. An attention index is created that measures input complexity.

At step 212 of the present disclosure, the one or more hardware processors 104 are configured to design a generative artificial intelligence (Gen AI) based model with a task scheduler that is simulated using the final BUI metric. The Gen AI based model comprises one more neuron sensing layers, one or more hidden layers, one or more optimization layers, one or more management layers, and a plurality of attention layers. The plurality of attention layers are implemented with a dynamic attention mechanism that adjusts focus of the Gen AI based model for performing one or more task oriented activities based on the complexity measure associated each of the plurality of preprocessed input data. The attention layers in LLMs, like those used in transformer architectures (e.g., Generative Pre-training Transformer (GPT), Bidirectional Encoder Representations from Transformers (BERT)), could be enhanced to assign variable attention weights based on real-time assessment of input complexity. This involves using the final BUI metric for each of the plurality of preprocessed input data, where higher complexity triggers greater attention allocation to key features. The attention index enables LLMs to concentrate computational resources on more critical elements of the input, mimicking how the human brain focuses its cognitive resources on complex tasks.

Further, at step 214 of the present disclosure, the one or more hardware processors 104 are configured to enable the Gen AI based model to perform one or more human-like cognitive functions with improved efficiency and decision making. The one or more human-like cognitive functions performed by the Gen AI based model comprises at least one (i) a task prioritization based on task complexity and memory requirements, (ii) parallel processing using multiple attention heads, (iii) neural activation simulation through selective activation of at least one of: (a) one or more hidden layers, and (b) one or more neurons in the Gen AI based model based on task difficulty, (c) latency-aware processing by adjusting response time of the Gen AI based model based on the task complexity and task latency, (d) dynamic resource allocation using an attention index, and (e) fatigue handling using a fatigue management layer from the one or more management layers of the Gen AI based model.

The task scheduler performs task prioritization based on their complexity and memory requirements. This would simulate how the brain chooses to address simpler tasks first or allocates more resources to complex ones. Further, a multitasking system is provided that uses multiple attention heads or parallel processing units to manage several tasks at once. The human brain can handle multiple tasks by switching focus. LLMs can mirror this by leveraging multiple attention heads to process inputs in parallel. The plurality of attention layers can be used to handle separate tasks in parallel, with each task's complexity determining how many attention heads or layers are assigned to it. Task-specific embeddings are used that adjust based on the input's complexity and cognitive load, guiding the LLM model's focus across tasks. The LLM model becomes better at multitasking by efficiently splitting computational resources across tasks based on their relative difficulty and importance.

The neural activation is simulated through selective activation of the one or more layers hidden or the one or more neurons based on task difficulty. The number of active neurons could be modulated based on the task's sensitivity and complexity, ensuring that computational power is used more efficiently. Neuron gating mechanisms where only a subset of neurons (or computational units) is activated depending on input complexity and sensitivity. This mirrors neural activation in the human brain. Activation thresholds are used based on sensitivity factors. For highly sensitive inputs, a larger portion of neurons are activated, while less complex tasks activate fewer neurons. The LLM becomes more energy-efficient and scalable, adjusting neural activation dynamically based on input sensitivity and importance.

Further, a latency-aware processing system is used where the LLM model adjusts its response time based on the complexity and latency of the task. Tasks with higher sensitivity or importance could be processed faster, while others are deprioritized, akin to how the brain processes high-priority stimuli more quickly. Latency management modules are added to a LLM architecture to adjust speed of execution for different tasks. High-priority or time-sensitive tasks reduce latency, while low-priority tasks show a higher latency to save computational resources. A latency optimization layer is incorporated that tracks an average processing speed and adjusts based on neural load. LLMs optimize their response time based on the complexity of the input, ensuring that critical tasks receive faster processing while less urgent tasks are queued.

The fatigue management layer of the Gen AI based model manages resource allocation and prevents overload by tracking the amount of computational power being used and redistributing one or more tasks when one or more parts of the Gen AI based model attain a fatigue nature. This means that the fatigue management layer tracks how much computational power is being used and redistributes tasks when certain parts of the model are fatigued. This simulates neural fatigue in the human brain, allowing the LLM to manage resource allocation and prevent overload. A fatigue-tracking mechanism is added that monitors the load on different computational layers. If a particular layer is overused, then the LLM model can redirect processing to less fatigued layers. Distributed computing strategies are used to prevent fatigue in specific components of the LLM model by balancing the load across available resources. The LLM becomes more robust and less prone to overloading, ensuring continuous, efficient performance even under heavy computational tasks.

In an embodiment, for long-term optimization for LLMs, adaptive learning and neuroplasticity is incorporated, and human-like responses are generated. For the adaptive learning and neuroplasticity, a self-adapting architecture is used in the LLM architecture where the LLM model becomes more efficient over time. Like the human brain's neuroplasticity, LLMs can adjust how they process data based on past experiences (i.e., learning from feedback). Dynamic weights or learnable attention mechanisms are used that adjust based on the complexity of the input over time. The LLM model learns to prioritize certain types of tasks and optimize processing by reducing unnecessary computations for familiar tasks. For this, a BUI-adapted learning framework is used where the LLM model tracks and improves its utilization over time, similar to how the brain adapts to new challenges. As a result, the LLM model becomes more efficient as it processes similar tasks repeatedly, mimicking neuroplasticity and improving over time. For human-like responses, a human-like response system is designed in the LLM architecture by combining cognitive load management with neural efficiency. This allows LLMs to simulate how humans balance emotional state, task complexity, and latency to produce more accurate and contextually appropriate responses. Emotional state detection mechanisms that allow the LLM model are to adjust responses based on contextual emotional cues from the input (inspired by the emotional regulation factor). Latency-adjusted response systems are used where neural fatigue and task priority dynamically influence the LLM model's processing power, ensuring that responses are generated quickly and accurately for complex queries. As a result, LLMs respond more naturally, simulating human-like reasoning and emotional awareness while maintaining computational efficiency.

In an embodiment, by applying the final BUI metric to LLM architectures, a gap between current AI capabilities and human-like cognition is bridged. The final BUI metric lies in range of 0-1 or scaled value and is computed after a batch of tasks (or periodically). The final BUI metric provides a holistic view of the LLMs overall efficiency across multiple interactions. The use of BUI-inspired modifications in LLMs such as dynamic attention allocation, neural gating, and latency-aware processing allows LLMs to better handle multitasking, optimize resource allocation, and perform more efficiently under stress or high computational load. This lays the foundation for the next generation of LLMs that adapt over time through neuroplasticity-like mechanisms, mimic human multitasking capabilities by balancing attention and cognitive load, and respond dynamically to task complexity, latency, and fatigue, much like the human brain optimizes neural pathways for different challenges. If BUI-inspired modifications in LLMs are based on real-time first BUI metric and second BUI metric, then adjustments are local, affecting immediate task execution. For example, if latency (L) is high, then model depth is reduced for quick responses. If memory load (M) is excessive, then context window is truncated dynamically. However, if BUI-inspired modifications in LLMs are based on the Final BUI metric, then adjustments are global, modifying LLM architecture for future tasks. For example, if BUI trends show chronic fatigue, then the token processing rate per step is reduced. If BUI scores suggest inefficient memory utilization, then context-aware embeddings are increased.

The integration of cognitive and neurobiological elements into LLM architectures represents a significant step forward in creating more human-like AI systems. As BUI-based models evolve, LLMs not only become more efficient but also more emotionally aware, capable of handling complex real-world tasks with the same flexibility and resilience that humans exhibit. This transforms how AI interacts with humans, making responses more intuitive, accurate, and aligned with human reasoning processes.

The written description describes the subject matter herein to enable any person skilled in the art to make and use the embodiments. The scope of the subject matter embodiments is defined herein and may include other modifications that occur to those skilled in the art. Such other modifications are intended to be within the scope of the present disclosure if they have similar elements that do not differ from the literal language of the embodiments or if they include equivalent elements with insubstantial differences from the literal language of the embodiments described herein.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated herein by the following claims.

What is claimed is:

1. A processor implemented method, comprising:
receiving, via one or more hardware processors, a plurality of input data pertaining to one or more task oriented activities;
preprocessing, via the one or more hardware processors, the plurality of input data using one or more preprocessing techniques to obtain a plurality of preprocessed input data;
computing, via the one or more hardware processors, (i) a first brain utilization index (BUI) metric using a plurality of cognitive factors and (ii) a second brain utilization index (BUI) metric using a plurality of neurobiological factors for each of the plurality of preprocessed input data, wherein the plurality of cognitive factors comprises (i) an attention factor, (ii) a memory load factor, (iii) a task complexity, (iv) a cognitive fatigue factor, and (v) an emotional state factor, and wherein the plurality of neurobiological factors comprises (a) number of sensitive neurons, (b) a neuronal sensitivity factor, (c) an input time processing factor complexity, (d) a neurobiological fatigue factor, and (e) a latency factor;
obtaining, via the one or more hardware processors, a final BUI metric by integrating the first BUI metric and the second BUI metric for each of the plurality of preprocessed input data;
determining in real time, via the one or more hardware processors, a complexity measure associated each of the plurality of preprocessed input data using the final BUI metric;
designing, via the one or more hardware processors, a generative artificial intelligence (Gen AI) based model with a task scheduler that is simulated using the final BUI metric, wherein the Gen AI based model comprises one more neuron sensing layers, one or more hidden layers, one or more optimization layers, one or more management layers, and a plurality of attention layers, wherein the plurality of attention layers are implemented with a dynamic attention mechanism that adjusts focus of the Gen AI based model for performing one or more task oriented activities based on the complexity measure associated each of the plurality of preprocessed input data; and
enabling, via the one or more hardware processors, the Gen AI based model to perform one or more human-like cognitive functions with improved efficiency and decision making, wherein the one or more human-like cognitive functions performed by the Gen AI based model comprises at least one (i) a task prioritization based on task complexity and memory requirements, (ii) parallel processing using multiple attention heads, (iii) neural activation simulation through selective activation of at least one of: (a) one or more hidden layers, and (b) one or more neurons in the Gen AI based model based on task difficulty, (c) latency-aware processing by adjusting response time of the Gen AI based model based on the task complexity and task latency, (d) dynamic resource allocation using an attention index, and (e) fatigue handling using a fatigue management layer from the one or more management layers of the Gen AI based model.

2. The processor implemented method of claim 1, wherein the first brain utilizing index (BUI) metric is computed as
$${BUI}_{1} = \frac{α ( A ) + β ( M ) + γ ( {T}_{1} ) + δ ( {F}_{1} ) + ϵ ( E )}{α + β + γ + δ + ϵ} ,$$
where A represents the attention factor, M represents the memory load factor, T₁ represents the task complexity, F₁ represents the cognitive fatigue factor, E represents the emotion state factor, and α, β, γ, δ, ∈ represent weights that adjust an importance of each of the plurality of cognitive factors based on a context.

3. The processor implemented method of claim 1, wherein the second brain utilizing index (BUI) metric is computed as
$${BUI}_{2} = \frac{N \times S \times {T}_{2}^{0.5}}{L \times {F}_{2}} ,$$
where N represents number of sensitive neurons, S represents a neuronal sensitivity factor, T₂ represents an input time processing factor, L represents a latency factor, and F₂ represents the neurobiological fatigue factor.

4. The processor implemented method of claim 1, wherein the number of sensitive neurons is modulated based on (i) a task sensitivity, and (ii) the task complexity to ensure an efficient computational power utilization.

5. The processor implemented method of claim 1, wherein the fatigue management layer of the Gen AI based model manages resource allocation and prevent overload by tracking amount of computational power being used and redistributing one or more tasks when one or more parts of the Gen AI based model attain a fatigue nature.

6. A system, comprising:
a memory storing instructions;
one or more communication interfaces; and
one or more hardware processors coupled to the memory via the one or more communication interfaces, wherein the one or more hardware processors are configured by the instructions to:
receive a plurality of input data pertaining to one or more task oriented activities;
preprocess the plurality of input data using one or more preprocessing techniques to obtain a plurality of preprocessed input data;
compute (i) a first brain utilization index (BUI) metric using a plurality of cognitive factors and (ii) a second brain utilization index (BUI) metric using a plurality of neurobiological factors for each of the plurality of preprocessed input data, wherein the plurality of cognitive factors comprises (i) an attention factor, (ii) a memory load factor, (iii) a task complexity, (iv) a cognitive fatigue factor, and (v) an emotional state factor, and wherein the plurality of neurobiological factors comprises (a) number of sensitive neurons, (b) a neuronal sensitivity factor, (c) an input time processing factor complexity, (d) a neurobiological fatigue factor, and (e) a latency factor;
obtain a final BUI metric by integrating the first BUI metric and the second BUI metric for each of the plurality of preprocessed input data;
determine a complexity measure associated each of the plurality of preprocessed input data using the final BUI metric;
design a generative artificial intelligence (Gen AI) based model with a task scheduler that is simulated using the final BUI metric, wherein the Gen AI based model comprises one more neuron sensing layers, one or more hidden layers, one or more optimization layers, one or more management layers, and a plurality of attention layers, wherein the plurality of attention layers are implemented with a dynamic attention mechanism that adjusts focus of the Gen AI based model for performing one or more task oriented activities based on the complexity measure associated each of the plurality of preprocessed input data; and
enable the Gen AI based model to perform one or more human-like cognitive functions with improved efficiency and decision making, wherein the one or more human-like cognitive functions performed by the Gen AI based model comprises at least one (i) a task prioritization based on task complexity and memory requirements, (ii) parallel processing using multiple attention heads, (iii) neural activation simulation through selective activation of at least one of: (a) one or more hidden layers, and (b) one or more neurons in the Gen AI based model based on task difficulty, (c) latency-aware processing by adjusting response time of the Gen AI based model based on the task complexity and task latency, (d) dynamic resource allocation using an attention index, and (e) fatigue handling using a fatigue management layer from the one or more management layers of the Gen AI based model.

7. The system of claim 6, wherein the first brain utilizing index (BUI) metric is computed as
$${BUI}_{1} = \frac{α ( A ) + β ( M ) + γ ( {T}_{1} ) + δ ( {F}_{1} ) + ϵ ( E )}{α + β + γ + δ + ϵ} ,$$
where A represents the attention factor, M represents the memory load factor, T₁ represents the task complexity, F₁ represents the cognitive fatigue factor, E represents the emotion state factor, and α, β, γ, δ, ∈ represent weights that adjust an importance of each of the plurality of cognitive factors based on a context.

8. The system of claim 6, wherein the second brain utilizing index (BUI) metric is computed as
$${BUI}_{2} = \frac{N \times S \times {T}_{2}^{0.5}}{L \times {F}_{2}} ,$$
where N represents number of sensitive neurons, S represents a neuronal sensitivity factor, T₂ represents an input time processing factor, L represents a latency factor, and F₂ represents the neurobiological fatigue factor.

9. The system of claim 6, wherein the number of sensitive neurons is modulated based on (i) a task sensitivity and (ii) the task complexity to ensure an efficient computational power utilization.

10. The system of claim 6, wherein the fatigue management layer of the Gen AI based model manages resource allocation and prevent overload by tracking amount of computational power being used and redistributing one or more tasks when one or more parts of the Gen AI based model attain a fatigue nature.

11. One or more non-transitory machine-readable information storage mediums comprising one or more instructions which when executed by one or more hardware processors cause:
receiving a plurality of input data pertaining to one or more task oriented activities;
preprocessing the plurality of input data using one or more preprocessing techniques to obtain a plurality of preprocessed input data;
computing (i) a first brain utilization index (BUI) metric using a plurality of cognitive factors and (ii) a second brain utilization index (BUI) metric using a plurality of neurobiological factors for each of the plurality of preprocessed input data, wherein the plurality of cognitive factors comprises (i) an attention factor, (ii) a memory load factor, (iii) a task complexity, (iv) a cognitive fatigue factor, and (v) an emotional state factor, and wherein the plurality of neurobiological factors comprises (a) number of sensitive neurons, (b) a neuronal sensitivity factor, (c) an input time processing factor complexity, (d) a neurobiological fatigue factor, and (e) a latency factor;
obtaining a final BUI metric by integrating the first BUI metric and the second BUI metric for each of the plurality of preprocessed input data;
determining in real time a complexity measure associated each of the plurality of preprocessed input data using the final BUI metric;
designing a generative artificial intelligence (Gen AI) based model with a task scheduler that is simulated using the final BUI metric, wherein the Gen AI based model comprises one more neuron sensing layers, one or more hidden layers, one or more optimization layers, one or more management layers, and a plurality of attention layers, wherein the plurality of attention layers are implemented with a dynamic attention mechanism that adjusts focus of the Gen AI based model for performing one or more task oriented activities based on the complexity measure associated each of the plurality of preprocessed input data; and
enabling the Gen AI based model to perform one or more human-like cognitive functions with improved efficiency and decision making, wherein the one or more human-like cognitive functions performed by the Gen AI based model comprises at least one (i) a task prioritization based on task complexity and memory requirements, (ii) parallel processing using multiple attention heads, (iii) neural activation simulation through selective activation of at least one of: (a) one or more hidden layers, and (b) one or more neurons in the Gen AI based model based on task difficulty, (c) latency-aware processing by adjusting response time of the Gen AI based model based on the task complexity and task latency, (d) dynamic resource allocation using an attention index, and (e) fatigue handling using a fatigue management layer from the one or more management layers of the Gen AI based model.

12. The one or more non-transitory machine readable information storage mediums of claim 11, wherein the first brain utilizing index (BUI) metric is computed as
$${BUI}_{1} = \frac{α ( A ) + β ( M ) + γ ( {T}_{1} ) + δ ( {F}_{1} ) + ϵ ( E )}{α + β + γ + δ + ϵ} ,$$
where A represents the attention factor, M represents the memory load factor, T₁ represents the task complexity, F₁ represents the cognitive fatigue factor, E represents the emotion state factor, and α, β, γ, δ, ∈ represent weights that adjust an importance of each of the plurality of cognitive factors based on a context.

13. The one or more non-transitory machine readable information storage mediums of claim 11, wherein the second brain utilizing index (BUI) metric is computed as
$${BUI}_{2} = \frac{N \times S \times {T}_{2}^{0.5}}{L \times {F}_{2}} ,$$
where N represents number of sensitive neurons, S represents a neuronal sensitivity factor, T₂ represents an input time processing factor, L represents a latency factor, and F₂ represents the neurobiological fatigue factor.

14. The one or more non-transitory machine readable information storage mediums of claim 11, wherein the number of sensitive neurons is modulated based on (i) a task sensitivity, and (ii) the task complexity to ensure an efficient computational power utilization.

15. The one or more non-transitory machine readable information storage mediums of claim 11, wherein the fatigue management layer of the Gen AI based model manages resource allocation and prevent overload by tracking amount of computational power being used and redistributing one or more tasks when one or more parts of the Gen AI based model attain a fatigue nature.
